(19) United States
(12) Patent Application Publication
(10) Pub. No.: US 2009/0144361 A1
(43) Pub. Date: Jun. 4, 2009

(54) MULTIMEDIA ADMINISTRATION, ADVERTISING, CONTENT & SERVICES SYSTEM

(76) Inventors: Lida NOBAKHT, Los Gatos, CA (US); James R. W. Clymer, Fresno, CA (US)

Correspondence Address: PILLSBURY WINTHROP SHAW PITTMAN LLP, P.O. BOX 10500, MCLEAN, VA, 22102, US

(21) Appl. No.: 12/257,154

(22) Filed: Oct. 23, 2008

Related U.S. Application Data
(60) Provisional application No. 60/982,089, filed on Oct. 23, 2007.

(51) Int. Cl. G06F 15/16; G06Q 30/00; G06Q 10/00; H04L 9/32; G06F 21/00

(52) U.S. Cl. 709/203; 705/14; 705/10; 709/217; 726/5; 726/30; 709/219

(57) ABSTRACT

The invention relates to multimedia, and more particularly to systems and methods for providing multimedia administrative, advertising, content and services. According to aspects of the invention a method of accessing data by a user at a client system comprises: reading user specific information from a first smart card by a client system, the information including a user specific electronic serial number; transmitting the user specific information to a server; processing the user specific information by the server to determine user authorization to access data; and providing the user is authorized, receiving data from the server by the client at the client system. The data can be an advertisement, an electronic coupon, a system initiation routine for first time users, access data allowing the client system to access data on the smart card, among others.

### CROSS-REFERENCE TO RELATED APPLICATIONS

This application claims the benefit of U.S. Provisional Application Ser. No. 60/982,089 filed Oct. 23, 2007, which is expressly incorporated by reference herein.

### FIELD OF THE INVENTION

The invention relates to multimedia, and more particularly to systems and methods for providing multimedia administrative, advertising, content and services.

### BACKGROUND OF THE INVENTION

Certain inventions and technologies pioneered by ViaCLIX™ have dramatically advanced the state of the art, including the inventions and technologies described in U.S. Pat. Nos. 6,587,873, 6,745,223, 6,785,716, 6,813,639, and 7,111,051 and U.S. Patent Pub. No. 2004/0205155, all incorporated herein by reference. Certain additional inventions and technologies have been developed by the present inventors which improve the delivery and manipulation of multimedia content.

### SUMMARY OF THE INVENTION

The invention relates to multimedia, and more particularly to systems and methods for providing multimedia administrative, advertising, content and services.

Certain embodiments that provide example Administrative Applications according to the invention include: SmartStart™—a process that is contained on a smart card that acts as a predefined wizard to help the user set up their service, including setting-up accounts for each family member; SmartUser™—a smart card that contains an individual's on-line account information that personalizes the user interface, such as the language used for text, graphics, etc., access permissions, URL favorites, passwords for on-line accounts, personal email accounts, etc.; SmartYouth™—a smart card that has built-in safety features limiting system access by the youth, the access limits being specified by the person controlling the SmartStart™ set-up process; SmartID™ is a readable/writable smart card that has a combination of encoded information that can positively identify the user, including pictures, biometric data, emergency medical information, etc.; and SmartGame™—an interactive game (entertainment) and interactive gaming (gambling) capability that is supported on the Client System as well as on remote servers for multi-user games. Real-time advertising and SmartIM™ may be implemented for games that are not timed. SmartID™ and SmartUser™ may be implemented as part of the game or gaming access permissions process.

Certain embodiments that provide example Advertising Applications according to the invention include: SmartCoupon™—an advertising facility, SmartCoupon™ may be mailed to a user, or written onto the user's SmartUser™ card; SmartLoyalty™—a smart card that is an adjunct to any commercial loyalty program and may be defined and used by a single commercial entity or a group of commercial entities; SmartMaster™—a master loyalty card that can contain all of the user's airline frequent flier mileage, hotel visits, car rental, store and on-line purchases, etc.; SmartBanner™—similar to SmartAds™ and SmartCoupon™, the SmartBanner™ process displays an alpha blended banner advertisement on the user's Client System display when accessing a related website or during a live stream advertisement; SmartStream™—enables alpha blending of video advertisements on top of video and computer generated advertisement content over video and vice versa; and SmartBillboard™—an alpha blended window which pops up when the user's cursor hovers over an icon on any of the menu or content screens.

Certain embodiments that provide example Financial Applications according to the invention include: SmartBank™—a smart card application that operates on the customer side of a bank's computer firewall in a similar manner to a debit card and may be used as a method for paying bills and moving cash in a secure form; and SmartMoney™—a smart card application that may be used in place of a credit card, may be used on-line (similar to Pay Pal) and in a limited manner pierces the bank's computer firewall.

Certain embodiments that provide example Communications Applications according to the invention include: Smart™—a technology that will consolidate multiple Instant Messaging streams and display them in time sequence as a separate scrollable text, window-in-picture, window-in-window or crawler that moves horizontally across the display; SmartTalk™—a technology that is similar to SmartIM™ but implements a confluence of VoIP streams and presents a composite audio stream to the Client System, Mobile Client or Remote Client user; and SmartVoIP™—a smart card that permits a Client System, Remote Client or appropriately equipped Mobile Client to log-on to the Internet for the purpose of communicating worldwide via Voice over Internet Protocol technology.

Certain embodiments that provide example underlying technologies according to the invention include: Video-Sync-to-Text—a technology that is most useful for education and reference purposes where a video feed may contain within the IP packet synchronization keys to display one or more text/graphics windows as their subjects are being presented in the video stream; Alpha Blending Content—“ABC,” permits the overlaying of video on top of video, computer generated content over video and vice versa; Remote Video Source Selection (RVSS) permits the Client System user to select one or more video sources to be displayed on the Client System Display device; Active Walled Garden™—a network related facility that only allows the Client System user to go to specific websites that are pre-determined either by the recommended sites on the Access Server 122a or pre-determined by the person setting up the user account with the SmartStart™ smart card; Multiple Live Video Pages—live video feeds that are scaled by the Channel Server 121b and are either grouped by function (e.g. Sports, News, etc.) or by other means (e.g. language, adjacent channels, HD channels, etc.) on the user's display; Peripheral Piggyback—a device that attaches to another device such as a cell phone or personal digital assistant that adds additional features and functions to the host device; Game Station—a technology that provides for an emulation of popular video games to be executed on the Game Server 123d and uses the Client System as a “thin client”; Smart Peripheral—a peripheral device subsystem that is designed to facilitate adding various Smart components to an electronic device that was not originally designed to support them and has, as a minimum, a smart card reader and a connection to a Personal Computer 301; SmartUpgrade™—a service that permits a Client System to be remotely upgraded on both a routine basis and an on demand basis without the user having to participate in the process.

According to aspects of the invention a method of accessing data by a user at a client system comprises: reading user specific information from a first smart card by a client system, the information including a user specific ESN; transmitting the user specific information to a server; processing the user specific information by the server to determine user authorization to access data; and providing the user is authorized, receiving data from the server by the client at the client system. The data can be an advertisement, an electronic coupon, a system initiation routine for first time users, access data allowing the client system to access data on the smart card, among others.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 is a block diagram of a System Architecture according to the invention;

FIG. 2 is a block diagram of a first Client System—Embedded Client—according to the invention;

FIG. 3 is a block diagram of a second Client System—Personal Computer—according to the invention;

FIG. 4 is a block diagram of a third Client System—Mobile Client—according to the invention;

FIG. 5 is a block diagram of a fourth Client System—Remote Client—according to the invention;

FIG. 6 is a view of a screen layout according to the invention;

FIG. 7 is a view of a video frame and overlay according to the invention;

FIG. 8 is a view of a video frame and a crawler according to the invention;

FIG. 9 is a view of a video frame with a second video frame overlay;

FIG. 10 is a view of a video frame with an overlay showing the position of cameras on a playing field according to the invention; and

FIG. 11 is a view of a video frame with eight overlays—one each for the eight cameras of FIG. 10—according to the invention.

### DETAILED DESCRIPTION OF THE PREFERRED EMBODIMENTS

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

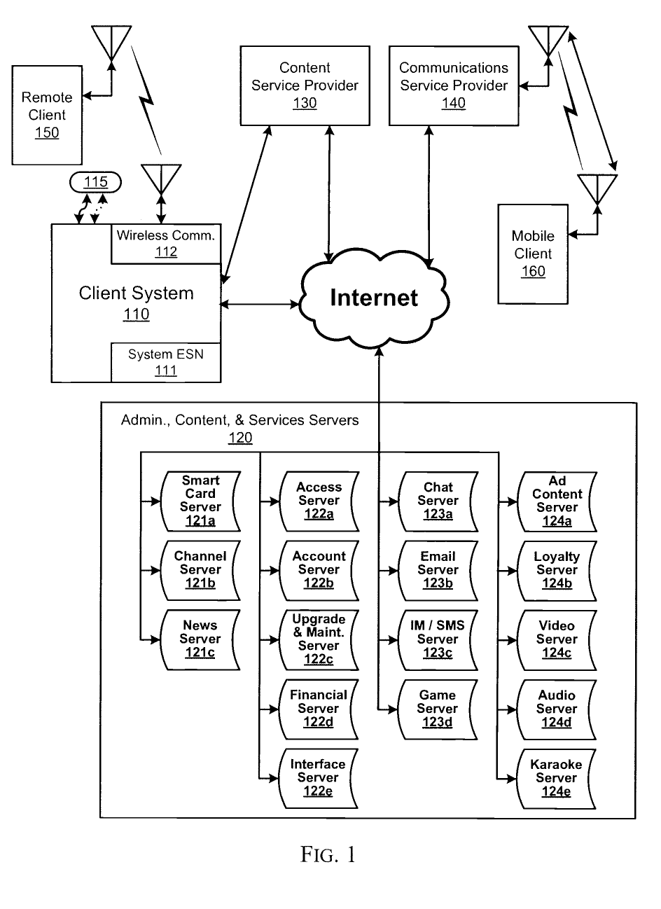

An advertising, administration, and content services system includes an array of servers, routers, switches and load balancing equipment, for example, upon which a variety of application specific software programs reside. The overall system is depicted in FIG. 1. The system is a channel based system utilizing a client system 110, a smart card 115 and a server system 120. Account initiation and administration, advertising content and delivery control and proprietary and licensed content will be provided by the administrative, content and services servers 120. The client 110 and server 120 communicate via a network such as the Internet, a virtual private network (VPN) or a local area network (LAN). The network may be wire or optical cable (e.g., DVB-C/DOCSIS), telephony (e.g., DSL), or radio frequency (e.g., WiFi, WiMax, satellite (DVB-S/S2), CDMA, G3, etc.).

The administration, content and services servers include the following servers: smart card server 121a; channel server 121b; news server 121c; access server 122a; account server 122b; upgrade and maintenance server 122c; financial server 122d; interface server 122e; chat server 123a; email server 123b; IM/SMS server 123c; game server 123d; advertisement content server 124a; loyalty server 124b; video server 124c; audio server 124d; and karaoke server 124e.

The client system 110 is connected to the Internet and may be connected directly to a content service provider 130 via cable, satellite or terrestrial content transmission and/or a communications or Internet service provider (ISP) 140. The communications service provider 140 may offer one or more communications services as either a public or private utility and may offer digital or analog voice, data or video services including satellite phone or data, cell phone or data, cable television and Internet Protocol, WiMax, etc. Internet communications service providers 140 (such as Google, Yahoo and MSN) and content service providers 130 (such as Comcast, DirecTV and Apple) distribute audio, video or Internet browser content through landline, terrestrial, cable or satellite physical mechanisms to individuals via monocast and/or multicast transmissions. Many of these content providers utilize a medium that permits a reverse channel capability to respond to, or through, the content provider.

The client system 110 may be an application specific, embedded client such as a ViaCLIX™ system, a set top box such as those manufactured by Scientific Atlanta, General Instrument, Motorola, Thompson, etc., a personal computer, a cell phone, a personal digital assistant or other programmable device.

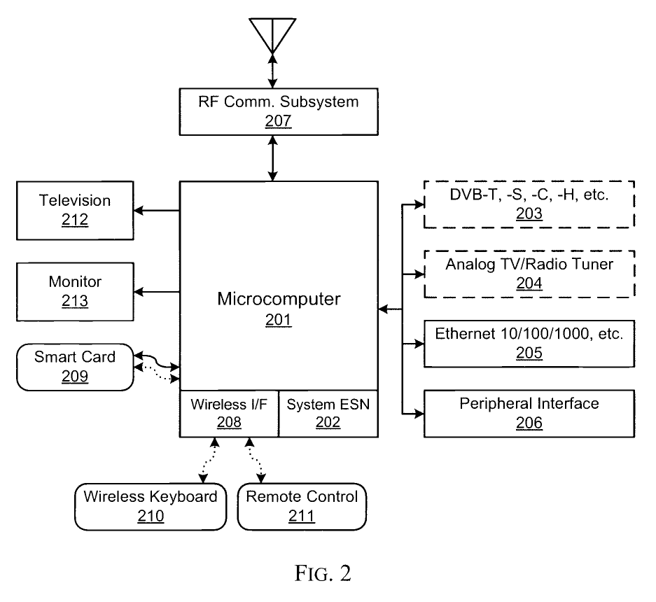

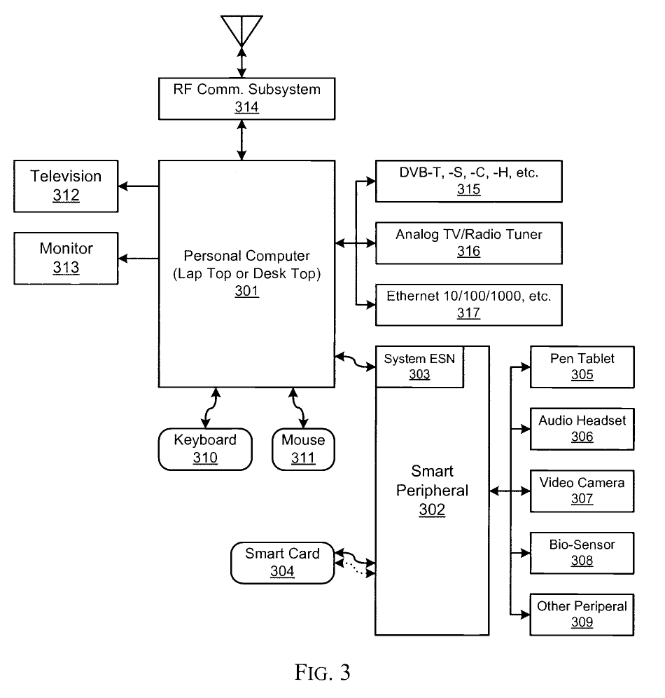

The multimedia system of FIG. 1 contemplates a client system 10 whose display device is a cathode ray tube, liquid crystal display, plasma display or other visual imaging device as currently implemented as a monitor, television, video or picture projector, automated bulletin board, automated billboard, cell phone, personal digital assistant, or virtual display device. See FIGS. 2 and 3. Future displays may include holographic devices. Audio output from the client system is accomplished through stereo, monaural, surround sound (e.g. Dolby-5.1, -7.1, -DTS) and a variety of audio transducers, and may be enabled through wired or wireless technologies (e.g. radio frequency devices including Bluetooth, Zigbee, WiFi 802.11 a/b/g/n, and ultra wide band or through infra-red (IR) or visual spectrum technologies).

The client system 110 has an asset management facility that is implemented with an electronic serial number (ESN) 111. Each time the client system is turned on, has a different smart card 115 inserted, or changes a channel or URL, a packet is sent to the server with the client system ESN, the smart card ESN and the channel number or URL, the mode that the system was in (e.g. personal computer or channel based system software and the location and activities occurring in the client system) and the time of the event. Furthermore, each remote client 150 and mobile client 160 will have a unique ESN. This ESN is used to identify the location of the client in the network, and in conjunction with a smart card, to specifically identify and validate the user of the system and to permit access to features available in the extended network.

The client system 110 has a wireless communications interface 112 for one or more of the following purposes: for peripheral system connection of a keyboard and remote control that does not use an infra-red link; connection of one or more audio headsets or handsets; connection to a video camera or other computer peripheral; and connection to a remote client 150.

The remote client 150 is a completely independent system that may be tethered to the client system 110 via radio frequency communications. The remote client may take the form of a remote control device, a remote control device with additional peripheral devices attached to it (e.g. headphones, microphone, camera, etc.), or an indirectly connected client (e.g. an 802.11 client that is connected via a remote “hot spot”). In addition, the remote client 150 may also be used as a security system complete with video camera and motion sensors, for example, or as a controller for turning on, or off, lights, HVAC and other items in the home or office.

The remote client 150 will be self scaling to accommodate various video output formats, as well as, re-scaling the displayed contents when the remote client is rotated from portrait mode (the major-axis of the display is aligned vertically) to landscape mode (the major-axis of the display is aligned horizontally), or vice versa. The remote client may also contain the graphical or textual user interface for remote control of the client system 110 and in one embodiment will have a touch screen 502b for selection of various system functions, including: channel previewing by video, pictures or graphics; instant messaging/short message service (IM/SMS); displaying email; telephony or voice over Internet (VoIP); etc. A remote client without a touchpad interface may be used in a similar fashion. However, the function selection will occur by using a scroll control and an enter button in a manner similar to a cell phone or television remote control.

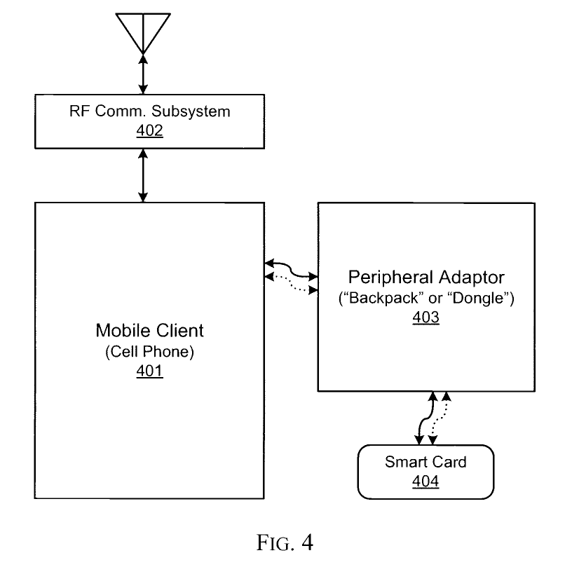

FIG. 5 shows a remote client 501, such as a remote control or PDA. The remote client 501 is shown with: an LCD display 502a and touch panel 502b; an RF communications subsystem 503a and RF sniffer 503b; and an interface to a smart card 504.

The mobile client 160 is a device such as a mobile phone or cell-phone. When the mobile client is a mobile phone, it may have multiband/multifunction capabilities (e.g. telephony, SMS, DVB-H, etc.) and may have an additional 802.11 WiFi capability for accessing a client system 110 or remote client 150. When the mobile client is a cell phone, it may be connected to a communications network through a GSM, CDMA or other radio frequency public or private utility or by connecting to a client system via Bluetooth, WiFi, or WiMAX. The communications service provider 140 can provide the mobile client 160 access to all of the content and communications services. Mobile and remote clients 160, 150 can participate in two-way interactions with a client system 110 or they can communicate directly with any other networked systems or subsystems. The display on the mobile client may be used as a surrogate for the non-portable client display. In a similar manner the mobile client's audio system may also be used instead of, or in conjunction with, the client system audio.

FIG. 4 shows a mobile client 401, in this case a cell phone, which includes an RF communication subsystem 402. The mobile client 401 is connected to a peripheral adaptor 403 (also known as a “backpack” or “dongle”) which has an interface for a smart card 404.

FIG. 2 shows an embedded client in a personal computer. The microcomputer 201 is shown with a system ESN 202; a radio frequency interface 203 for DVB-T, -S, -C, -H, etc.; an analog TV/radio tuner 204; an Ethernet 10/100/1000, etc. connection 205; a peripheral interface 206; an RF communication subsystem 207; a wireless interface 208 for a wireless keyboard 210 and remote control 211; an interface for a smart card 209; and connections for a television 212 and monitor 213.

Referring to FIG. 3, a personal computer 301 may also be positioned as a client system with certain intrinsic limitations. For example, personal computers do not have the capability to handle video with the same performance as a ViaCLIX™ client system nor do they have the capability of supporting PAL/NTSC/SECAM standards. Other limitations relate to the inability to support alpha blending or seamless control of audio/visual content. Also, karaoke requires the independent control of the left and right audio channels and personal computers are not able to support this function. However, by adding a smart peripheral 302 and with one or more peripheral device attachments—for example, one or more of pen tablet 305, audio headset 306, video camera 307, bio-sensor 308 and other peripherals 309—most of the features of a client system 110 can be supported. The smart peripheral includes a system ESN 303 and an interface for a smart card 304.

The personal computer 301 may be a lap top or desk top computer and is shown with a radio frequency interface 315 for DVB-T, -S, -C, -H, etc.; an analog TV/radio tuner 316; an Ethernet 10/100/1000, etc. connection 317; an RF communication subsystem 314; a keyboard 310 and remote control (mouse) 311; and connections for a television 312 and monitor 313.

The smart cards used in the invention meet the relevant parts of International Standards Organization ISO-7816 standard. There are a number of different elements that are specified, including: ISO 7816-8, which codifies internal card commands for security operations; ISO 7816-10, which specifies the power, signal structures, and the structure for the answer to reset between an integrated circuit card(s) with synchronous transmission and an interface device such as a terminal; ISO 7816-11, which specifies personal verification through biometric methods; and ISO 7816-15, which specifies cryptography standards. In addition, there are two other specifications that the smart cards may satisfy, depending on their use. First is the EMV Company, LLC (formed by Europay, MasterCard and Visa) “Integrated Circuit Card Specifications for Payment Systems”. These specifications are related to ISO7816 and create a common technical basis for card and system implementation of a stored value system. Second is the national standards for implementing a secure electronic health transaction system in the U.S adopted under the Health Insurance Portability and Accountability Act (HIPAA). Example transactions affected by this include claims, enrollment, eligibility, payment and coordination of benefits. Smart cards are governed by the requirements of HIPAA in the U.S. for data security and patient privacy.

Table I provides a summary of typical smart card characteristics suitable for a range of smart cards of the present invention. Card type specifies one of: MEM, which is a memory card; MCU, which is a microprocessor card; and RFC, which is a RF/contactless memory card. Card form factor specifies one of: CR-80/8 8-Pin Card; CR-80/6 6-Pin Card; GSM SIM/SAM Card; and Keychain Card. Encryption refers to the presence of encryption software on the card and requires an MCU.

TABLE I

| | | Card Form | | Magnetic |
|---|---|---|---|---|
| Smart Card | Card Type | Factor | Encryption | Stripe(s) |
| SmartStart ™ | MEM | CR-80/8 | NO | NO |
| SmartYouth ™ | MEM | CR-80/8 | NO | NO |
| SmartID ™ | MCU | ANY | OPTION | NO |
| SmartGame ™ | MCU | CR-80/8 | YES | OPTION |
| SmartCoupon ™ | MEM | ANY | NO | NO |
| SmartLoyalty ™ | MEM | CR-80/8 | NO | OPTION |
| SmartMaster ™ | MCU | CR-80/8 | NO | OPTION |
| SmartBank ™ | MCU | CR-80/8 | YES | YES |
| SmartMoney ™ | MCU | CR-80/8 | YES | YES |

Certain embodiments that provide example administrative applications according to the invention will now be described with reference to the attached figures.

A first embodiment is called SmartStart™. SmartStart™ is a process that is contained on a smart card that acts as a predefined wizard to help the user through the set up routine for their service. Once the basic service is connected for an account it will then help the customer set-up associated accounts for each family member, or other user.

Each client system has a unique ESN, each smart card has a unique ESN, and each family member, or other user, has a personal smartcard. For service initiation the service provider creates a smart card “package” for each customer that includes a SmartStart™ card, a SmartMaster™ card and an adult card or child's card, as appropriate, for each family member. A customer order is generated by the service provider's customer service department with all of the customer related information and a description of the service components that the customer is signing up for. The service provider then creates a SmartStart™ and SmartMaster™ smart card utilizing the customer information. SmartStart™ contains customer location and other appropriate service information for service initiation and serves as the “master” smartcard for initializing the individual user smart cards.

With reference to FIG. 1, when the SmartStart™ card is plugged in to the client system it sends a packet of information to the account server 122b that executes an initiation routine that enables the client system 110 setup. Then the master user (SmartStart™ user) will insert one of the blank smart cards into the system 110 at a time and the customer will step through a set-up wizard for access permissions for each family member.

A next embodiment is called SmartUser™. The SmartUser™ smart card contains an individual's on-line account information that personalizes the user interface, such as the language used for text, graphics, etc., access permissions, URL favorites, passwords for on-line accounts, personal email accounts, etc. This is a personalized identification card for a single user that facilitates multiple people using the same client system. For example, a SmartUser™ smart card may contain: client system and network log-in information; the user's graphical user interface preferences; e-mail, chat and other account information; and subscriptions, passwords and on-line account information. Maintaining this information on the SmartUser™ card precludes the user having to maintain this information database and it will help to maintain personal security.

A next embodiment is called SmartYouth™. The SmartYouth™ smart card is similar in concept to the SmartUser™ smart card, but, has some other built-in safety features that may be enabled or disabled by the person controlling the SmartStart™ set-up process. Also see below the description of Active Walled Garden™.

With reference to FIG. 1, the system has an access server 122a which contains recommended, age appropriate websites, parent approved email and approved chat/IM/SMS partners for the child/youth. During the first access by the child using the SmartYouth™ card the appropriate GUI is downloaded onto the client system 110. Thereafter, the GUI is updated each time there is an upgrade available on the server 122a. If the SmartYouth™ card is used on another client system it is downloaded there, also, and erased when the card is removed if the client system is not the user's home system. Every time a smart card is inserted into a client system a packet of information is sent to the access control server to determine the access permits.

A SmartYouth™ type of card may also be used to control, or limit, access to various Internet-based resources for corporations and public service institutions and those entities that require “need to know” or other security clearances for access to files on a private network. Furthermore, the SmartYouth™ card can also be used to turn off features of the client system, or personal computer, such as “Print.”

A next embodiment is called SmartID™. SmartID™ is a readable/writable smart card that has a combination of encoded information that can positively identify the user. The card may contain pictures, biometric data, emergency medical information, etc. The identity information is written on the SmartID™ card and then a fuse is blown that creates a fence that does not allow the region of the smart card that has been previously written to be modified—it becomes a read-only zone on the smartcard. Encryption software is an option on the SmartID™ card, and may be used to control who may see the data on the card.

A smartcard enabled for SmartID™ is programmed in a pre-defined file format to contain personal information such as a picture and finger print image. The personal identification data is also stored on the server 120 in the account server 122a or loyalty server 124b data bases. This information may be used for identification purposes by comparing with data collected from a finger print biosensor, for example. It is preferred to use the identity information from the server 120, although the copy on the SmartID™ card is used when the server cannot be contacted. Note that biosensors can include fingerprinting, retinal scanning, voice identification, etc. Furthermore, emergency contact and medical information can also be stored on the card as well as such items as a “living will”.

The SmartID™ card process will vary depending on the type of identification required. For example, in a bank the identification may require a fingerprint and/or a picture and the process might proceed as follows. The user approaches the bank teller or ATM machine and inserts his SmartID™ card. If the transaction is a withdrawal or transfer of cash or other assets, then the user's picture can be sent via the ATM's or bank's security camera for comparison with the picture data on the server 120 or SmartID™ card. In a similar manner the user's fingerprint may be scanned on a biosensor and compared to the data on the SmartID™ card. Assuming that the user passes the comparison tests, then the requested transaction is completed.

A next embodiment is called SmartGame™. SmartGame™ is an interactive game (entertainment) and interactive gaming (gambling) capability that can be supported on the client system as well as on a remote server—game server 123d—for multi-user games. Real-time advertising and SmartIM™ (see below) may be implemented for games that are not timed. SmartID™ and SmartUser™ may be implemented as part of the game or gaming access permissions process. Furthermore, SmartBank™ and/or SmartMoney™ (see below) may be used as payment or betting tokens.

There are many applications for on-line game and gaming. There are also many restrictions on on-line gaming due to local, state, national and international laws. Some of these laws impose geographical restrictions on where gaming can be done, require age confirmation and restrict forms of payment. In addition, some games are high-speed and/or timed games while others are relatively slow or even static with no time constraints. The “Smart” features contained herein will satisfy all of these issues, but, they must be customized for each region and service provider.

Regarding the geographical restrictions, there are essentially two ways to determine the location of a client system, whether it is a mobile client or just a client system that you take on a trip. The first way is with an IP Address: the account server 122b has a record of a user's home IP address and therefore the system can determine if the user is at home. If the user is not at home, the system can locate the user in a general area up to the node of the current IP address that the user is accessing. The second way is for a cell phone, in which case the system can check the user location by requesting the cell phone's global positioning system (GPS) latitude, longitude and altitude.

Certain embodiments that provide example advertising applications according to the invention will now be described with reference to the attached figures.

A first embodiment is called SmartCoupon™. As an advertising facility, SmartCoupon™ may be mailed to a user. Alternatively, a coupon may be written on the user's SmartUser™ card.

When a client system user goes on-line a packet of information regarding his or her personal information is sent to the access server 122a. Information regarding the location of the client system 110 may be gleaned from its system ESN 111 by “pinging” the client system. Each website that the user visits will cause an additional packet of user information to be sent to the access server. All of this information is available on the server 120 to match a coupon to the consumer interests and location of the user. An appropriate SmartCoupon™ is generated and sent to the user. Inserting the SmartCoupon™ in the user's client system will direct the system to the advertiser's website where the coupon may be redeemed or other promotional materials or actions may be obtained. Note that the coupon is either written onto the client system's hard disk for later printing or is copied to the user's smart card. This is done on the client system.

A next embodiment is called SmartLoyalty™. There are many types of loyalty programs that people use: airline miles, hotel visits, book purchases, on-line sales, gasoline purchases, etc. The SmartLoyalty™ smart card is an adjunct to any commercial loyalty program and may be defined and used by a single commercial entity or may be associated with a group of commercial entities.

The customer identification issues are discussed above. There may be many ways to implement SmartLoyalty™, however, there are two key ways to utilize the SmartLoyalty™ application. Firstly, SmartLoyalty™ can also be a derivative of SmartID™. The picture/finger print identification can be used for airport, hotel, or other check-in services and may be used to record or use frequent flyer or frequent visit points. Secondly, the SmartLoyalty™ card can also be used as a room key or as a key for any kind of entry key or permission either alone or in conjunction with a biosensor. A loyalty card server 124b contains the appropriate applications software to support the loyalty programs.

The SmartLoyalty™ card works whether or not the hotel desk or airport counter is able to read the card. For example, the user checks in, following the normal process for the hotel/airline. If the specific check-in facility can read the SmartLoyalty™ card, then the card is shown on check-in for discounts, upgrades, etc., and the card as well, as the central account on the hotel/airline's database is decremented appropriately. Upon check out (or completion of the flight or purchase) the card is swiped again and incremented appropriately. If the specific check-in facility cannot read the SmartLoyalty™ card, then the hotel/airline will identify the customer and adjust the account on the database appropriately at check-in and check-out. When the user can access a client system he can insert his SmartLoyalty™ card and the loyalty information will be updated on the card.

A next embodiment is called SmartMaster™. SmartMaster™ is a master loyalty card that can contain all of the user's airline frequent flier mileage, hotel visits, car rental, store and on-line purchases, etc. SmartMaster™ can be used to accumulate loyalty credits from all of the user's accounts regardless of the type of account it might be. In addition, this card may be used on-line to maintain website cookies, names, addresses, passwords and any other information associated with an on-line account in a secure manner due to the unique ESN and encryption facilities of the SmartMaster™ smart card.

A next embodiment is called SmartAds™. SmartAds™ are advertisements that are delivered to a user's client system that address products and subjects of personal interest that have been qualified by the user's use of the Internet, accessed through the client system.

When a client system user goes on-line a packet of information regarding his or her personal information is sent to the access server 122a. Information regarding the location of the client system 110 may be gleaned from its system ESN 111 by “pinging” the client system. Each website that the user visits will cause an additional packet of user information to be sent to the access server. All of this information is available on the server 120 to match an advertisement to the consumer interests and location of the user. A SmartAds™ is sent to the user. Clicking on the SmartAds™ will open a “window-in-picture” or a “window-in-window” for the advertising content to be delivered. Hovering over the advertisement will open a temporary window or media player which will dissolve when the pointer/cursor is moved away.

A next embodiment is called SmartBanner™. Similar to SmartAds™ and SmartCoupon™, the SmartBanner™ process displays an alpha blended banner advertisement on the user client system's display when accessing a related website or during a live stream advertisement. An example is the displaying of a Pepsi banner during a Coke commercial. In a live stream (real-time) the advertising agency knows what advertisements are going to be shown and the network embeds a time code for the advertising feed to start so that their stations can insert any local variation of the advertisement. In a situation where the local station does not have access to the time feeds there are two other ways to insert an alpha blended overlay: the advertising agency creating the advertisement can insert an audio sync in the advertisement or the local station's show producer may just link an insertion command. With a non-real-time show the process is much easier because all manner of overlays can be added. For example, a segment of a movie might show a BMW racing away in a car chase and the network or station may then blend in a national, regional or local BMW banner with the timing pre-determined.

When a client system user goes on-line a packet of information regarding his or her personal information is sent to the access server 122a. Information regarding the location of the client system 110 may be gleaned from its system ESN 111 by “pinging” the client system. Each website that the user visits will cause an additional packet of user information to be sent to the access server. All of this information is available on the server 120 to match an advertisement to the consumer interests and location of the user. A SmartBanner™ is sent to the user in real-time. Clicking on the SmartBanner™ will open a “window-in-picture” for the advertising content to be delivered.

A next embodiment is called SmartStream™. SmartStream™ permits the overlaying of video advertisements on top of video and computer generated advertisement content over video and vice versa. SmartStream™ as used herein features the alpha blending of advertisements on top of a video stream on a localized basis or on an individualized basis.

Each client system has a unique ESN which may be used to determine what advertisements or other content should be displayed on top of a specific video stream. For example, if there is a nationwide advertisement for a car company on a particular program the local alpha blending content advertisement may add something to the effect: “see your San Francisco BMW dealer on Van Ness Street or call 415-555-1234.”

SmartStream™ also provides the technology for the client system user to select a hotspot on the display with a pointing device. When selected, the advertising company may open a Billboard, media player window or other window on top of the video stream where the user can obtain additional information on a product or retailer. Making a SmartStream™ selection can also create a SmartCoupon™ on the SmartUser™ card or the ability to link to the advertiser's website.

A next embodiment is called SmartBillboard™. Hovering over an icon on any of the menu or content screens will create a window that does not have any skins or controls in the periphery; this window is called a SmartBillboard™.

When a pointing device hovers over an icon for a predetermined period of time a service request packet is sent to the ad content server 124a which, in combination with the client system ESN, will select the content that is displayed in the SmartBillboard™. The content can be any visual object or media that can be displayed in a media player and any audio content that can be listened to on the client system. This creates an opportunity to both personalize and to localize the content presented.

Certain embodiments that provide example financial applications according to the invention will now be described with reference to the attached figures.

A first embodiment is called SmartBank™. SmartBank™ is a smart card application that operates on the customer side of a bank's computer firewall in a similar manner to a debit card and may be used as a method for paying bills and moving cash in a secure form.

SmartBank™ requires that the client system user sets up a bank account with a financial institution. The Smart Bank™ smart card with its unique ESN in conjunction with a pre-determined Personal Identification Number (PIN) will securely identify the user whether the user is at the bank's ATM machine or at his own client system. The client system's 128-bit encryption algorithm is more than sufficient to protect any single transaction. Cash equivalents may then be transmitted to the user and securely written on the SmartBank™ card where it is again secured.

A next embodiment is called SmartMoney™. SmartMoney™ is a smart card application that may be used in place of a credit card, may be used on-line (similar to Pay Pal) and in a limited manner pierces the bank's computer firewall.

SmartMoney™ requires that the client system user sets up a bank account with a financial institution. The SmartMoney™ smart card with its unique ESN in conjunction with a predetermined PIN will securely identify the user whether the user is at the bank's ATM machine or at his own client system. The Client System's 128-bit encryption algorithm is more than sufficient to protect any single transaction. Cash equivalents may then be transmitted to the user and securely written on the SmartMoney™ card where it is again secured.

SmartMoney™ is an extension of SmartBank™ in that it can be used as a credit card on-line. In this implementation, the SmartMoney™ user selects an item to be purchased and the client system sends a token to the user's bank in conjunction with the financial server 122d. None of the user's personal information is transmitted on the Internet or to the establishment from which the user wants to make a purchase.

Certain embodiments that provide example communications applications according to the invention will now be described with reference to the attached figures.

A first embodiment is called SmartIM™. SmartIM™ is a technology that will consolidate multiple Instant Messaging (IM) streams and display them in time sequence as a separate scrollable text window-in-picture or window-in-window or crawler that moves horizontally across the display. This permits users that are not in proximity to each other to share the same experience of a movie, sporting event, etc. SmartIM™ also allows client system users to interact with television programs. Consolidation of IM streams can be for a group of users on a single IM facility or multiple IM facilities.

A next embodiment is called SmartTalk™. SmartTalk™ is a technology that is similar to SmartIM™ but implements a confluence of voice and/or video over Internet protocol (VoIP) streams and presents a composite audio and/or video stream to the client system, mobile client or remote client user. This permits users that are not in proximity to each other to share the same experience of a movie, sporting event, etc. Two different SmartTalk™ capabilities are available concurrently: a private conversation between two people and a multicast, party-line type of circuit.

A next embodiment is called SmartVoIP™. The SmartVoIP™ smart card permits a client system, remote client or appropriately equipped mobile client to log-on to the internet for the purpose of communicating worldwide via VoIP technology. Here both audio and video transmissions may be accommodated.

In the case of a client system, the SmartVoIP™ smart card has the account information necessary to create a VoIP voice, video or data phone call over the Internet to another SmartVoIP™ user or to a third party including POTS (i.e. a phone connected to a landline) or cell phones. If a SmartVOIP™ user has a remote client 150 (see FIG. 5) and the remote client has an RF Communications Subsystem 503a, it will then be equipped with an RF Sniffer 503b. The RF Sniffer will alert the user to an available radio frequency network where the user may make a phone call. As far as mobile clients 160 (see FIG. 4) are concerned, the SmartVoIP™ user may either make a cell phone call to an access point, or if equipped with a peripheral adapter 403, may locate a WiFi or WiMAX Internet interface with the attached transceiver and RF Sniffer.

Certain embodiments that provide example underlying technologies according to the invention will now be described with reference to the attached figures.

A first embodiment is called Video Sync-to-Text. Video-Sync-to-Text is a technology that is most useful for education and reference purposes where a video feed may contain within the IP packet synchronization keys to display one or more text/graphics windows as their subjects are being presented in the video stream. This technology is extremely important when the system user is attempting to study the relationship between an on-screen event and reference resources. For example, a physics teacher is lecturing on a phenomenon that can be represented with a third order integral equation. The viewer may need to refer to the course text book and a book of math tables simultaneously. Clicking on one of the windows would bring it to full screen and clicking on it again would return it to its original size and location. In the event that an experiment was also running it might be extremely important to also put that video feed in a separate window and not synchronize the text to video.

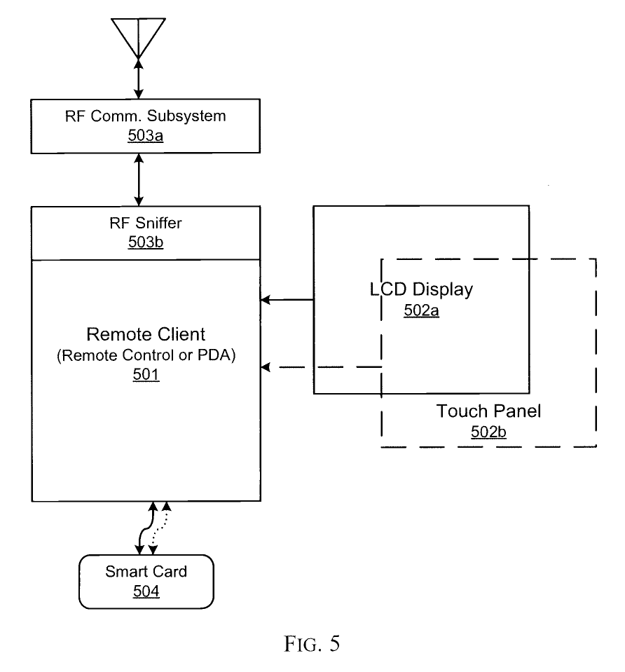

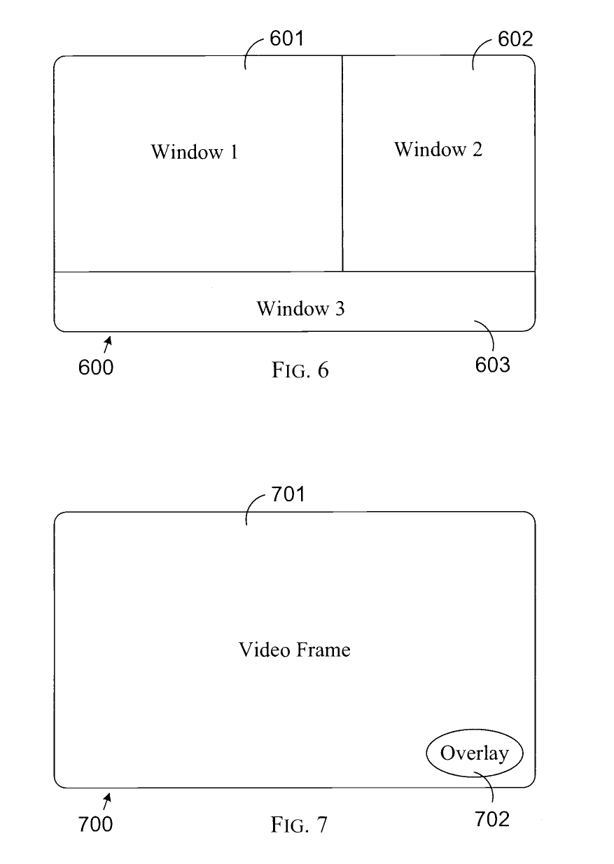

The designer of this type of application first decides on a set of rules for the screen layout. An example is shown below in FIG. 6. The technical information relating to the screen is contained in a “Screen File.” The screen file has information relating to the dimensions of each window, the location of the content on the server and whether the window can be maximized to fill the entire screen 600 by double clicking, or right clicking, in the window. This process may also include various “Trick Functions” (Pause, Stop, Fast Forward, etc.) that are normally employed with video. For example, the designer is preparing a foreign language tutorial and has defined Window 1 601 as a video window, Window 2 602 as a text window and Window 3 603 as a text window. Window 1 will have a video playing a language lesson, say in French. Window 2 will have the translation of the video in English text, and Window 3 will have the actual lesson from a text book. Each window points to a specific file and the files are managed with a second data file called the “Time Marker File.” This file contains information with regard to the “Master” window (in this case Window 1) to which the other windows are synchronized. The “Time Markers” define when an action is to occur with respect to the other windows.

Alpha blending, remote video source selection and Active Walled Garden™ (see below) may be employed with this feature.

A next embodiment is called alpha blending content. Alpha blending content (ABC) permits the overlaying of video on top of video, computer generated content over video and vice versa. ABC as used herein features the alpha blending of advertisements or other content on top of a video stream on a localized basis or on an individualized basis.

Each client system has a unique ESN which may be used to determine what advertisements or other content should be displayed on top of a specific video stream. For example, if there is a nationwide advertisement for a car company on a particular program the local ABC advertisement may add something to the effect: “see your San Francisco BMW dealer on Van Ness Street or call 415-555-1234.” ABC may occur by time synchronization, IP packet key synchronization, DVB metadata synchronization, analog television synchronization based upon out of band signaling for feed selection, synchronization on transition to “black,” or vertical retrace synchronization.

Alpha blending may be utilized with streaming content (real-time) or pre-recorded content. The system user (viewer) has selected a program to watch. The user's profile and geographical location is known by a combination of the client system asset number and the unique serial number on the user's smart card. The position on the TV or monitor is known either by an X-Y pixel coordinate or by time displacement of the individual frame scan thereby permitting alpha blending to occur in any screen location in any frame starting from a known point in time and geometry. The overlay may be any graphic (solid, text, or line drawing) or video form scaled to the required size and transparency for display on the screen.

An example of an overlay 702 on a video image 701 is shown below in FIG. 7. This image has been positioned in a predefined location on the screen 700 in the colors, transparency and size desired by the advertiser. The overlay 702 is clickable and the action that occurs after clicking is also predefined. The action can be immediate or may be delayed based upon the desire of the viewer. For example, a viewer may be interested in the ad but not want to disturb the flow of the program that he is watching. The delayed event will be stored in a “Favorites” location in the user's system. Similarly, the overlay may be ignored.

Although a video image is discussed above, the image can also be a graphic. This mode is valuable for advertising as the advertisement can be localized for the viewer's geographical area. For example a user is viewing a website advertising a product such as a television. The clickable overlay is for a discount at a store near the user's home location. When the overlay is clicked a new web page can be displayed showing the product and/or a coupon for use at the store.

Another application for this feature provides for the ability of the content provider to add other features for the viewer. For example, products used or worn in a particular scene of movie, statistics of a player or sports team, voting on an issue in real-time, or interacting with a game.

In addition to providing content providers with the alpha blending capability, a service provider, such as a cable, satellite or Internet service company could also add links and features to a presentation. Subtitles, breaking news, weather alerts, etc. can be added in real-time or at pre-defined times to the transmission.

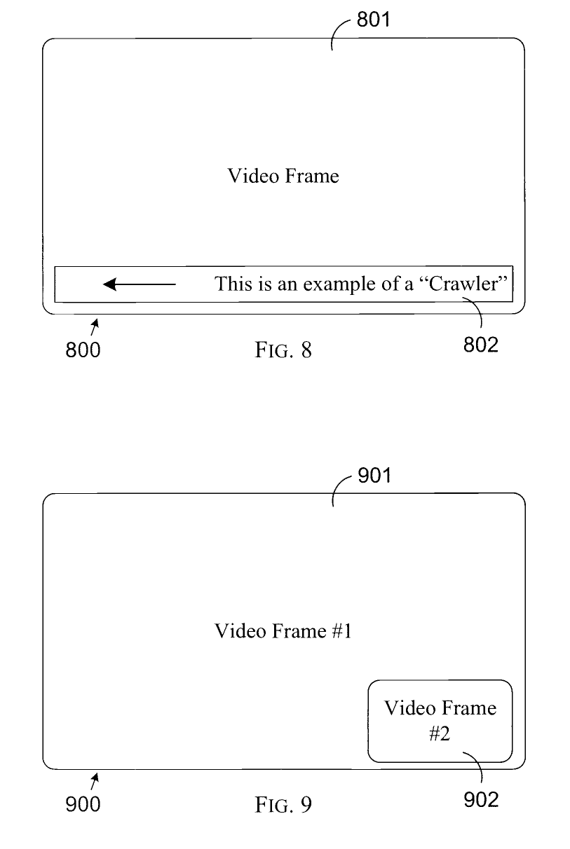

Examples of other types of alpha blending are shown in FIGS. 8 and 9. FIG. 8 shows a “crawler” 802 alpha blended with a video frame 801 along the bottom of the screen 800. This crawler 802 may be moved from right to left, left to right, top to bottom, or bottom to top as required for the language or the desired effect. FIG. 9 shows a screen 900 with a video frame 902, scaled, positioned and alpha blended over a full screen video or graphics image 901.

A next embodiment is called remote video source selection. Remote video source selection (RVSS) permits the client system user to select one or more video sources to be displayed on the client system display device.

Many sporting and educational events have multiple video cameras either for covering different regions of the field or for simultaneous outputs for multiple events. For the observation of multiple camera outputs using RVSS the video feeds will be scaled prior to transmission to the client system for display, or the user may select one video source at a time. MPEG-2 standards provide for multiple camera angles as well and the different camera angles may be selected one at a time.

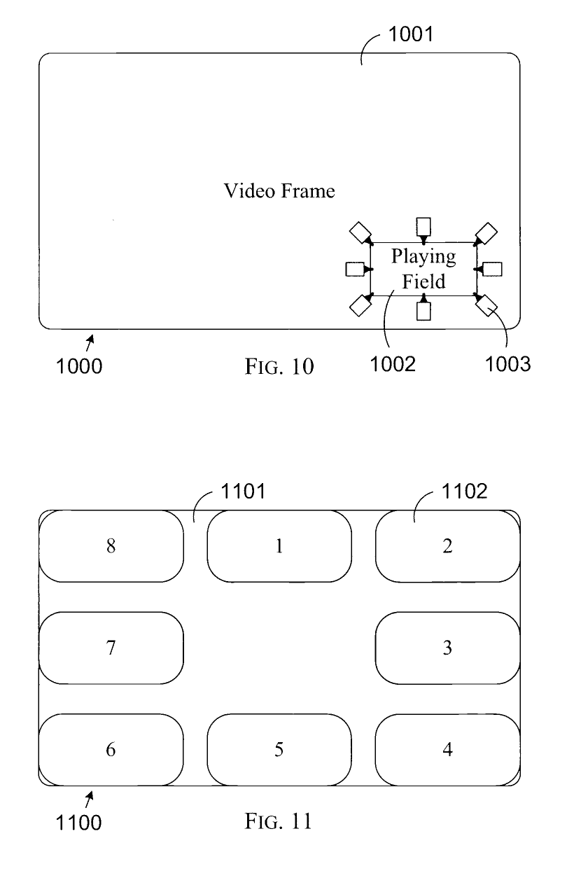

For example, consider the sports application of RVSS using a U.S. football venue analogy. Typically, producers of major sporting events have a number of cameras operating concurrently. Some may be in fixed locations and some may be mobile. FIG. 10 shows a screen 1000 with a playing field 1002 with the locations of 8 video cameras 1003 depicted in an alpha blended overlay on top of a video frame 1001. The scene to be viewed may be selected by the system user by either clicking on the overlay camera or entering a camera identifier, such as a number, from the remote control.

Another method of selecting a video source is presented in FIG. 11. In this method, the producer mixes the video from the various cameras and integrates the images in a single video frame 1101 on the screen 1100. By clicking on the individual camera image 1102 the system will switch to that view until the viewer selects another camera. Retuning to the home, or base page with the multiple images can be accomplished by using the “Back Arrow,” or equivalent.

An example of using this technology in an educational application is the training of surgeons. Using one of the techniques described above, the trainee may switch to different viewing angles of the surgery or to the anesthesiologist or to instruments that are monitoring the surgery.

Either of these types of applications—sports or education—can be further enhanced with video synchronization (viewing texts or data in concert with the event) and alpha blending to provide a graphical overlay. Furthermore, these applications can be enhanced by having the ability to branch to other ancillary sources of content.

A next embodiment is called Active Walled Garden™. An Active Walled Garden™ is a network related facility that only allows the client system user to go to specific websites that are predetermined either by the recommended sites on the access server 122a or pre-determined by the person setting up the user account with the SmartStart™ smart card.

The Active Walled Garden™ (AWG) provides a safe environment for children. The user of a SmartYouth™ smart card may only visit age appropriate websites that are pre-defined on the access server 122a, as defined by the parent on the child's smart card. AWG disables hotspots and hyperlinks on web pages that have been approved for access. In addition to pre-approved websites, the SmartYouth™ user is only permitted: to send/receive email to/from specified individuals; and chat, IM/SMS and play online games with pre-determined individuals.

The smart card set-up service with the SmartStart™ card may define access permissions during the first set-up or any time thereafter. This feature may also be used to control, or limit, access to various Internet-based resources for corporations and public service institutions and those entities that require “need to know” or other security clearances.

Unless the adult that is setting up the system features using the SmartStart™ card chooses differently, the system will boot up into a basic, child-safe “Walled Garden.” Leaving this mode requires the insertion of an adult, non-restricted SmartUser™ card. An older child having a SmartYouth™ card can modify this basic user interface by inserting his card, in which case the walled garden stays in place with a less limited content access. When a child enters an approved website he may roam within that site. However, if there is a link or other hotspot that will take the child to an unapproved website the action will be disabled.

A next embodiment is called multiple live video pages. Television channels are currently selected either from an electronic program guide or cardinally by depressing a channel-up/channel-down key on a remote control. The multiple live video pages are actual live video feeds that are scaled by the channel server 121b and are either grouped by function (e.g., sports, news, etc.) or by other means (e.g., language, adjacent channels, HD channels, etc.).

Referring to FIG. 1, the content service provider 130 and/or the individual client system user may determine the grouping of movie, video or other content channels. Whatever the channel grouping selection, four to sixteen live feeds will be scaled in conjunction with the channel server 121b and video server 124d and transmitted to the client system's channel selection guide. An example of multiple live video pages is shown in FIG. 11. The streaming media sources are first separated into subjects such as sports, news, music, movies, etc. Some quantity of these television stations are then selected to be scaled down in size and aggregated into a single video feed, as shown. By hovering over one of the television images a packet is sent to the server requesting an audio feed for that channel. Clicking on the video image will cause the system to select that channel for a full scale display.

A next embodiment is called peripheral piggyback. A peripheral piggyback is a device that attaches to another device such as a cell phone or personal digital assistant that adds additional features and functions to the host device. A peripheral piggyback may be used to enable new technologies to be implemented on existing client systems without having to purchase new clients. This facility also allows different technologies to be added or removed from the client system when traveling. This is especially important for cell phone RF technologies that are not the same as one travels, sometimes even within the same country. A peripheral piggyback permits the removal of extraneous peripheral devices when they are not needed and therefore decreases the size and power requirements. Furthermore, the peripheral piggyback may be used to house additional batteries and therefore increase the amount of time that the client system may be used before recharging.

The embodiment of the peripheral piggyback of particular interest is the ability to remotely connect a peripheral device to a host system. The preferred implementation of this capability is to use the microcontroller (MCU) in a remote control device to connect to a peripheral device utilizing the ubiquitous USB interface. The USB interface may also supply power to the peripheral device (up to 0.5 A at 5.0 VDC) or may be externally powered by a power adaptor. The MCU, using either direct memory access (DMA) hardware or under software control, will then wirelessly interface the peripheral device to the host system as if it were attached locally.

The range of peripherals that are desirable to connect to the remote control includes: smart cards; video cameras; microphones and headphones; headsets; still camera flash memory cards; pen tablets; game controllers; etc. Alternatives to the peripheral piggyback, for connecting peripherals to the remote control include 12C and 12S devices, for example.

A next embodiment is called game station. Game station technology provides for an emulation of popular video games to be executed on the game server 123d and uses the client system as a “thin client.”

There are many game consoles available on the market for high-speed video gaming, Play Station and X-Box being two of the more popular. In addition to game consoles, there are many network or server based games available. The game station will be an emulator software application that will run on a server and use one or more of the client systems as thin clients to implement the display and game controller functions required by the various games running on the server(s).

A next embodiment is called smart peripheral. Smart peripheral 302 is a peripheral device subsystem that is designed to facilitate adding various smart components to an electronic device that was not originally designed to support them and has, as a minimum, a smart card reader and a connection to a personal computer 301. See FIG. 3.

A smart peripheral smart card reader may have either a contact or contact-less smart card reader. If smart card writing is required for an application, then the smart card should engage a smart card socket. The most likely interface to a client would be a USB-2 wired connection, but FireWire or other high-speed connections may be used. Each smart peripheral must also have a system ESN 303.

An example of a smart peripheral is the remote control device mentioned in the peripheral piggyback section above. Though, a smart peripheral may also be connected directly to the host system or remotely using any communications technology.

A next embodiment is called SmartUpgrade™. SmartUpgrade™ is a service that permits a client system to be remotely upgraded on both a routine basis and on a demand basis without the user having to participate in the process.

Routine maintenance and upgrade services are provided that allow the client system's software to be remotely upgraded as new software releases become available. Upgrades will be provided when a client system user plugs a peripheral device into the client system that requires a driver or application program that is not currently installed. This feature provides the service provider with the opportunity to increase their business by selling peripheral devices to the client system users.

There are two different SmartUpgrade™ mechanisms: “routine” and “demand.” In the routine mode every time a host system comes on line it will interact with the head-end access control server 122a and request permission to connect to the network. Part of the information sent to the access control server includes the software release version in the client system 110. See FIG. 1. If the client system software release version is not current a dialog box with a question asking the user whether or not an update is desired will be sent to the client 110. If the answer is yes then the update proceeds. A message is then sent automatically from the access control server 122a to the head-end upgrade and maintenance server 122c to facilitate the system software upgrade. Depending upon the type of system, and the operations protocol of the service provider, either an immediate download and update will occur or it may be delayed until a time when the user of the system (from their own usage profile) does not normally use the client system.

In the demand mode: if a user attaches a peripheral to the system that requires a software interface (driver) that does not exist in the system software build, then a demand is sent to the head-end upgrade and maintenance server 122c to reconfigure the software on the client system with the necessary drivers, utilities and applications software, as required, and to upgrade the entire software package on the client system.

Although the present invention has been particularly described with reference to the preferred embodiments thereof, it should be readily apparent to those of ordinary skill in the art that changes and modifications in the form and details may be made without departing from the spirit and scope of the invention. It is intended that the appended claims encompass such changes and modifications.

1. A method of accessing data by a user at a client system comprising:
reading user specific information from a first smart card by said client system, said information including a user specific electronic serial number;
transmitting said user specific information to a server;
processing said user specific information by said server to determine user authorization to access data; and
providing said user is authorized, receiving data from said server by said client at said client system
wherein said smart card includes a read-only memory for storing personal identification data, wherein said user specific information includes said personal identification data and wherein said smart card includes an encryption program for encrypting said personal identification data.

2. A method as in claim 1, further comprising the step of sending client system location information to said server.

3. A method as in claim 2, wherein said client system location information includes a client electronic serial number.

4. A method as in claim 2, wherein said client system location information includes a user Internet Protocol address.

5. A method as in claim 2, wherein said client system location specific information includes global positioning system data.

6. A method as in claim 1, wherein said data received from said server permits said client system to access user information from said smart card.

7. A method as in claim 6, wherein said user information includes said user's graphical user interface preferences.

8. A method as in claim 6, wherein said user information includes said user's online account information.

9. A method as in claim 8, wherein said on-line account information includes said user's frequent flyer account information.

10. A method as in claim 1, wherein said user information includes said user's internet access permissions.

11. A method as in claim 10, wherein said internet access permissions are derived from a database of age appropriate websites, said database being on said server.

12. A method as in claim 10, wherein said internet access permissions are derived from a database of files accessible on a private network, said database being on said server.

13. A method as in claim 10, wherein said access permissions are set by a master user.

14. (canceled)

15. A method as in claim 1, wherein said personal identification data includes biometric data.

16. A method as in claim 15, further comprising:
collecting a fingerprint using a biosensor linked to said client system;
comparing said biometric data and said fingerprint to identify said user.

17. (canceled)

18. A method as in claim 1, further comprising:
sending client system location information to said server;
wherein said user authorization is determined by both said user specific electronic serial number and said client system location information.

19. A method of accessing data by a user at a client system comprising:
reading user specific information from a first smart card by said client system, said information including a user specific electronic serial number;
transmitting said user specific information to a server;
processing said user specific information by said server to determine user authorization to access data; and
providing said user is authorized, receiving data from said server by said client at said client system;
wherein said first smart card is an account initialization card and said data is a set-up routine for initializing multiple smart cards associated with a single account.

20. A method as in claim 19, further comprising:
reading user specific information from a second smart card by said client system;
entering user specific access permissions on said client system;
transmitting said user specific access permissions to said server; and
storing said user specific access permissions on said server.

21. A method of accessing data by a user at a client system comprising:
reading user specific information from a first smart card by said client system, said information including a user specific electronic serial number;
transmitting said user specific information to a server;
processing said user specific information by said server to determine user authorization to access data;
providing said user is authorized, receiving data from said server by said client at said client system;
sending to said server a history of websites visited by said user on said client system;
storing said history on said server; and
processing said history to determine said user's consumer interests;
wherein said data includes an electronic coupon matching said user's consumer interests.

22. (canceled)

23. A method as in claim 21, wherein said electronic coupon is written on to said smart card.

24. A method as in claim 1, further comprising:
sending to said server a history of websites visited by said user on said client system;
storing said history on said server; and
processing said history to determine said user's consumer interests;
wherein said data includes an advertisement matching said user's consumer interests.

25. A method as in claim 24, wherein said advertisement is displayed on said user's graphical user interface and wherein said advertisement is alpha-blended with the image on said graphical user interface.

26. A method as in claim 21, further comprising sending client system location information to said server, wherein said server also uses said client system location information to determine geographically relevant consumer information for said user, and wherein said electronic coupon matches said geographically relevant consumer information.
